(19) United States
(12) Patent Application Publication
(10) Pub. No.: US 2026/0116227 A1
(43) Pub. Date: Apr. 30, 2026

(54) CONNECTOR FOR FACILITATING CHARGING OF A CAPACITOR

(71) Applicant: Rivian IP Holdings, LLC, Irvine, CA (US)

(72) Inventors: Steven Ernest SCHULZ, Torrance, CA (US); Jason HUANG, Irvine, CA (US); Muhammad Mobeen MAHMOOD, Irving, TX (US); Jonathan Jiseop LEE, La Mirada, CA (US)

(21) Appl. No.: 18/933,193

(22) Filed: Oct. 31, 2024

(51) Int. Cl. B60L 53/22; H02H 7/12; H02M 1/32; H02M 3/07

(52) U.S. Cl. CPC B60L 53/22; H02H 7/1213; H02M 1/32; H02M 3/07; B60L 2210/10

(57) ABSTRACT

A DC-DC converter includes a current limiting device and a capacitor. A first interface is coupled to the capacitor and configured to couple to a second interface supplying an input voltage. The first interface is further configured to couple the input voltage to the capacitor through the current limiting device before coupling the input voltage to the capacitor in bypass of the current limiting device. The first interface may include pins of unequal lengths with a longer pin connected to the capacitor through the current limiting device and the shorter pin connected to the capacitor in bypass of the current limiting device.

### INTRODUCTION

The present disclosure relates to a connector for facilitating charging of a capacitor.

### SUMMARY

The present disclosure describes an approach for reducing inrush current and ringing when connecting a battery to a component including a capacitor. In one aspect, a circuit includes a current limiting device and a capacitor. A first interface is coupled to the capacitor and configured to couple to a second interface supplying an input voltage. The first interface is further configured to couple the input voltage to the capacitor through the current limiting device before coupling the input voltage to the capacitor in bypass of the current limiting device.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic block diagram illustrating the location of a DC-DC converter in an electric vehicle in accordance with certain embodiments.

FIG. 4 is a schematic block diagram of a DC-DC converter having a connector configured to reduce inrush current and avoid ringing upon connection of the DC-DC converter to a battery, in accordance with certain embodiments.

FIG. 5A illustrates the connector being aligned with a plug in accordance with an accordance with certain embodiments.

FIG. 5B illustrates the connector having certain pins connected to contacts of the plug at an intermediate stage of connecting the connector to the plug in accordance with certain embodiments.

FIG. 5C illustrates the connector and the plug fully connected to one another in accordance with certain embodiments.

FIG. 6 illustrates a circuit for charging the capacitor of a DC-DC converter in accordance with certain embodiments.

### DETAILED DESCRIPTION

A battery electric vehicle includes a high-voltage battery providing current to one or more inverters, which convert direct current (DC) from the battery to alternating current (AC) to drive the motors connected to the wheels. Although there are many advantages to having a high-voltage battery, most components of the vehicle require a lower voltage, e.g., electronic control units (ECU), smaller motors (e.g., driving the windshield wipers, windows, power liftgate, etc.), an infotainment system, and the like. A DC-DC converter is therefore used to generate current at a reduced voltage (e.g., 12 volts). The DC-DC converter includes a large capacitor that is charged initially upon connection to the battery and thereafter will remain at or near a charged state unless intentionally drained. Upon initial charging, the capacitor and the inherent inductance within wires coupling current to the capacitor, if coupled instantaneously, would create an underdamped frequency response, i.e., ringing, that can cause large oscillations in voltage with peak voltages exceeding 1000 volts.

The approach described herein provides an improved approach for coupling the DC-DC converter to the battery directly or by way of one or more intermediate components. The DC-DC converter includes a connector with two pins connected to the positive terminal of the capacitor: a first pin is connected to the positive terminal through a resistor and a second pin is connected to the positive terminal in bypass of the resistor. The connector further includes a third pin that is connected to the negative terminal of the capacitor. The first and third pins are longer than the second pin such that when a plug is brought into contact with the connector, the first and third pins will briefly make electrical contact with the plug while the second pin has not. The plug couples the first pin to the positive battery voltage and couples the third pin to the negative battery voltage. Initial current to the capacitor will therefore flow through the resistor. As the plug and connector are brought closer together, the second pin makes contact and is also coupled to the battery voltage, thereby providing a path to the capacitor in bypass of the resistor. The momentary coupling through the resistor is sufficient to charge the capacitor without ringing.

The approach described herein has the advantage of requiring minimal components (a resistor and associated wiring) to perform a function that is only used upon manufacture and eliminates the need for relays or other more complex components.

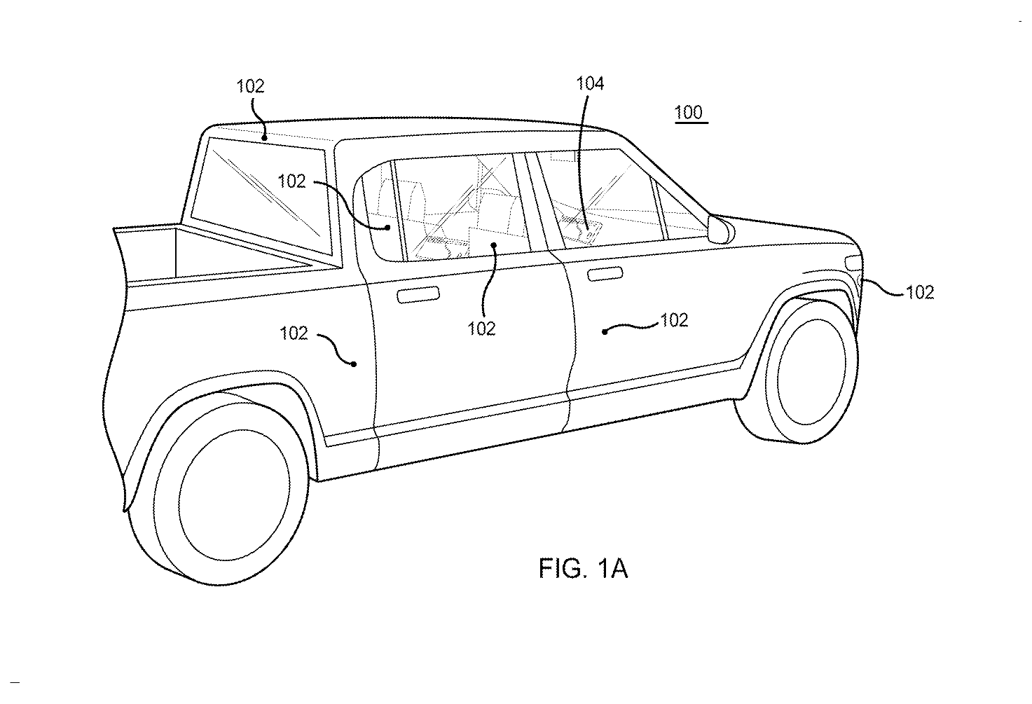

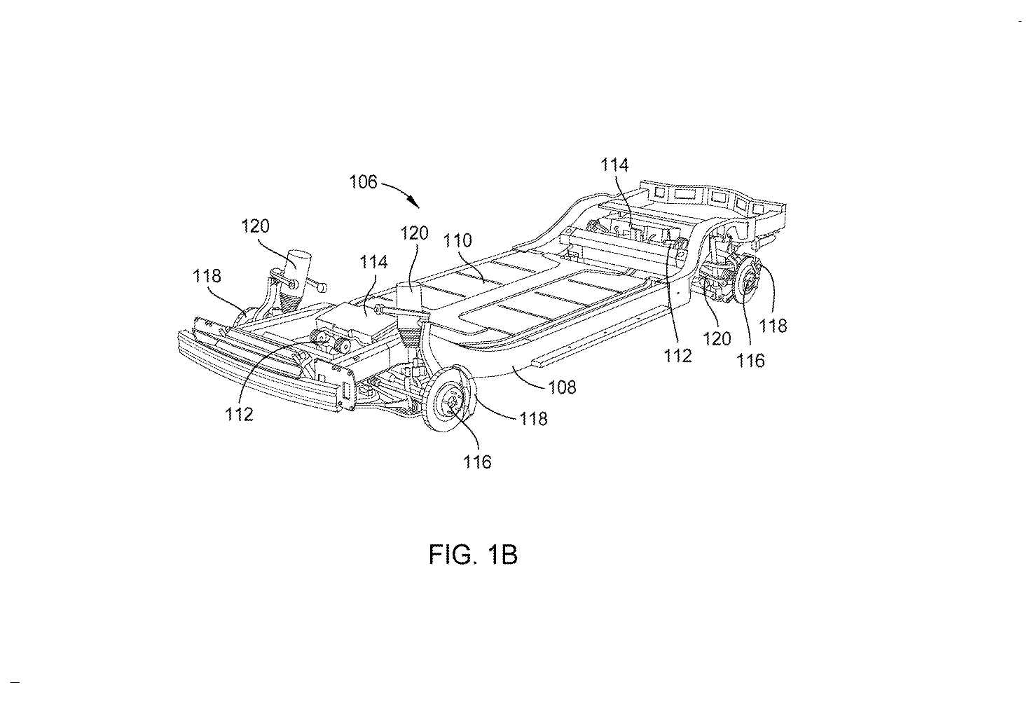

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, a hybrid-electric vehicle may also benefit from the approach described herein.

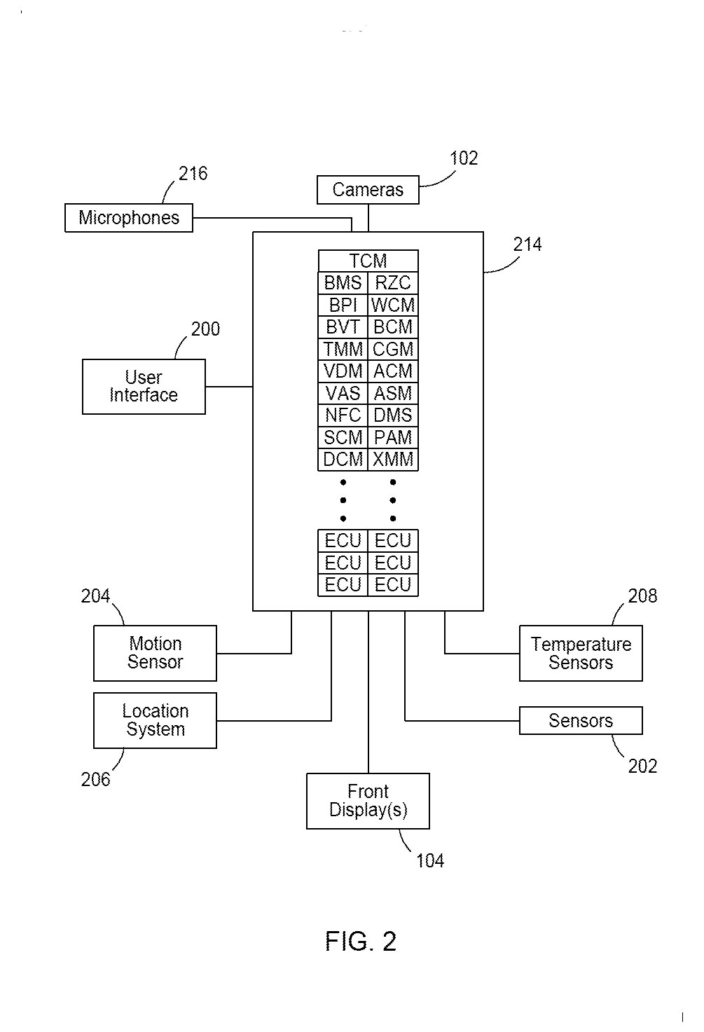

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power electronics 114, temperature of each drive unit 112 and/or each motor of each drive unit 112, temperature of coolant fluid entering or leaving a coolant system, temperature of oil within a drive unit 112, or the temperature of any other component of the vehicle 100.

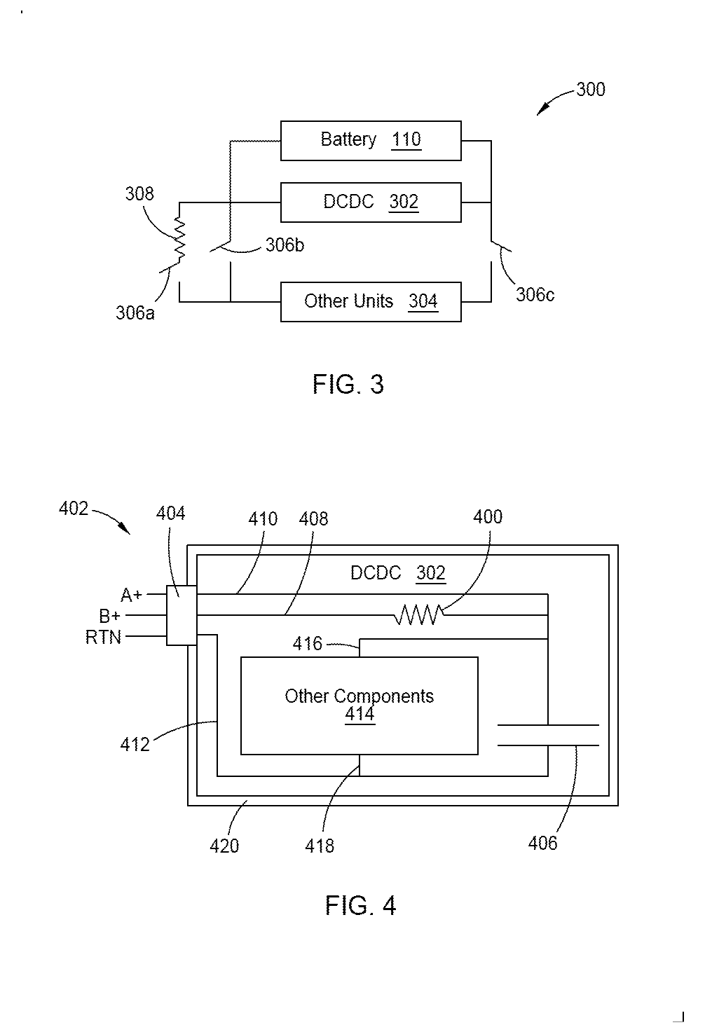

A control system 214 executes instructions to perform at least some of the actions or functions of the vehicle 100, including the functions described in relation to FIGS. 3 to 6. For example, as shown in FIG. 2, the control system 214 may include one or more electronic control units (ECUs) configured to perform at least some of the actions or functions of the vehicle 100, including the functions described in relation to FIGS. 3 to 6. In certain embodiments, each of the ECUs is dedicated to a specific set of functions. Each ECU may be a computer system and each ECU may include functionality described below in relation to Figs. FIGS. 3 to 6.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle’s communications hub that connects and transfers data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for performing, for example, the operations and functions described in relation to FIGS. 3 to 6.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

Referring to FIG. 3, the vehicle 100 may implement the illustrated circuit 300. The battery 110 is coupled to a DC-DC converter 302 and to other units 304 that take the high voltage (e.g., 400 to 800 volts) output by the battery, such as the power electronics 114 of the drive units 112, an on-board charger, or other components.

For emergency situations, it is desirable to decouple the other units 304 from the battery. Switches 306a, 306b, 306c are therefore provided. The switches 306a, 306b, 306c additionally provide two paths from the positive battery voltage to the other units 304, one of which includes a resistor 308. Accordingly, upon manufacturer or following maintenance, the other units 304 may first be coupled to the positive terminal by closing switches 306a and 306c and, after a brief delay (e.g., 10 to 100 milliseconds), closing switch 306b. Switch 306a may be opened or remain closed following closing of switch 306b. Accordingly, ringing due to capacitors of the other components may be reduced.

As is apparent in FIG. 3, the DC-DC converter 302 remains connected to the positive and negative battery voltages regardless of the state of the switches 306a, 306b, 306c. This approach is used to enable low-voltage components to continue to function to provide essential services, such as network connectivity. However, a consequence of this arrangement is that the DC-DC converter 302 does not benefit from the resistor 308.

Referring to FIG. 4, the DC-DC converter 302 may incorporate an internal resistor 400. In any of the embodiments disclosed herein, the resistor 400 may be replaced with some other type of current-limiting device, such as a diode, a transistor, a circuit including one or more transistors and one or more resistors, a lossy inductor, or other type of current-limiting device.

The DC-DC converter 302 may include a connector 402 including a connector body 404 and at least three pins: A+, B+, and return (RTN). The connector body 404 and pins A+, B+, and RTN may have a configuration, form factor, arrangement, or other attribute according to any standard known in the art, particularly those used in the motor vehicle industry, such as MOLEX, TE CONNECTIVITY/AMP, TE CONNECTIVITY/HIGH VOLTAGE INTERLOCK (HVIL), TE CONNECTIVITY/HVA 280, or the like. The connector body 404 and pins A+, B+, and RTN may use a connector standard that includes more than three pins with the other pins either being omitted, unused, or used for purposes unrelated to supplying power and reducing ringing as discussed herein.

The pin A+ is coupled to a first terminal of a capacitor 406 by electrical path 408 that includes the resistor 400. The pin B+ is coupled to the first terminal of the capacitor 406 by electrical path 410 that bypasses the resistor 400. The pin RTN is coupled by electrical path 412 to a second terminal of the capacitor 406. Other components 414 of the DC-DC converter are connected across the first and second terminals of the capacitor, such as by electrical paths 416, 418, e.g., that accomplish the reduction in voltage from the battery voltage to a lower voltage, such as a voltage from 12 to 48 Volts.

The pin B+ has limited use for charging the capacitor 406 as described below. The pin B+ likewise does not carry as much current as the pins A+ and RTN. The pin B+ may therefore be smaller in terms of diameter or other measure of cross-sectional area compared to the pins A+ and RTN. For example, the pin B+ may be rated to carry sustained current of less than 3 Amperes, such as between 2.2 and 1.8 Amperes, whereas the pins A+ and RTN are rated to carry sustained current of at least 10 Amperes or at least 16 Amperes.

The connector body 404 may be mounted to a housing 420 of the DC-DC converter 302a or otherwise be accessible through the housing 420. The capacitor 406, other components 414, and electrical paths 408, 410, 412, 416, 418 may also be positioned within the housing 420. The housing 420 may be made of metal (e.g., aluminum or steel) or rigid plastic (e.g., polypropylene, acrylonitrile butadiene styrene (ABS), or the like).

The capacitor 406 may function as a filter and may have a capacitance of, for example, 1 to 50 microfarads. A resistor 400 corresponding to such a capacitor 406 may have, for example, a resistance of 10 to 1000 Ohms. These values are exemplary only and other values may also be used.

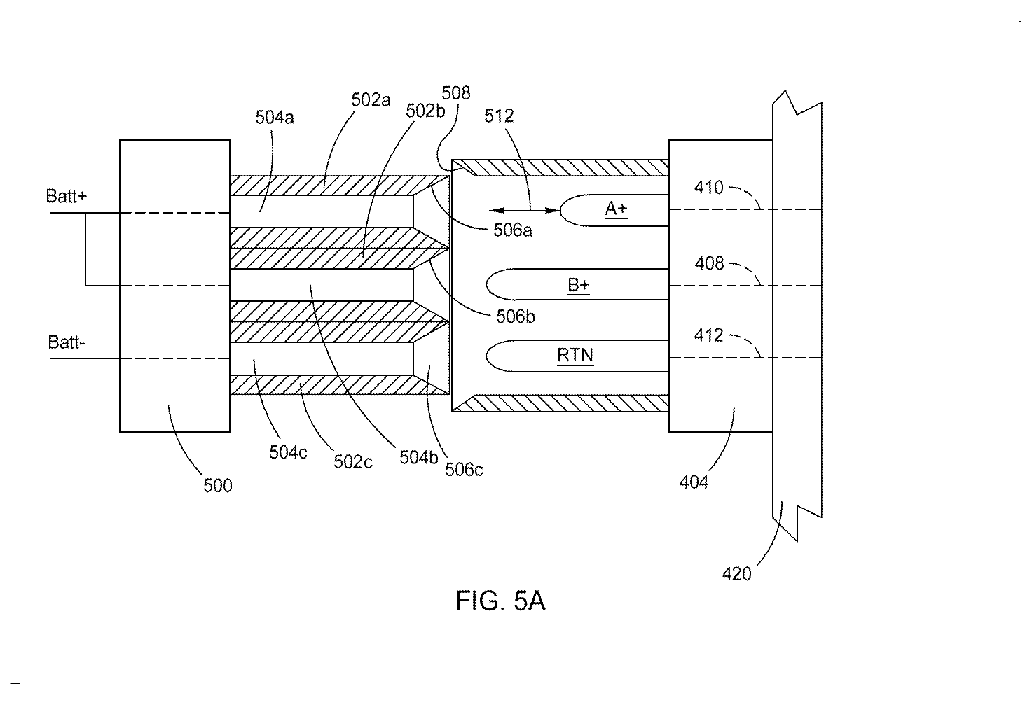

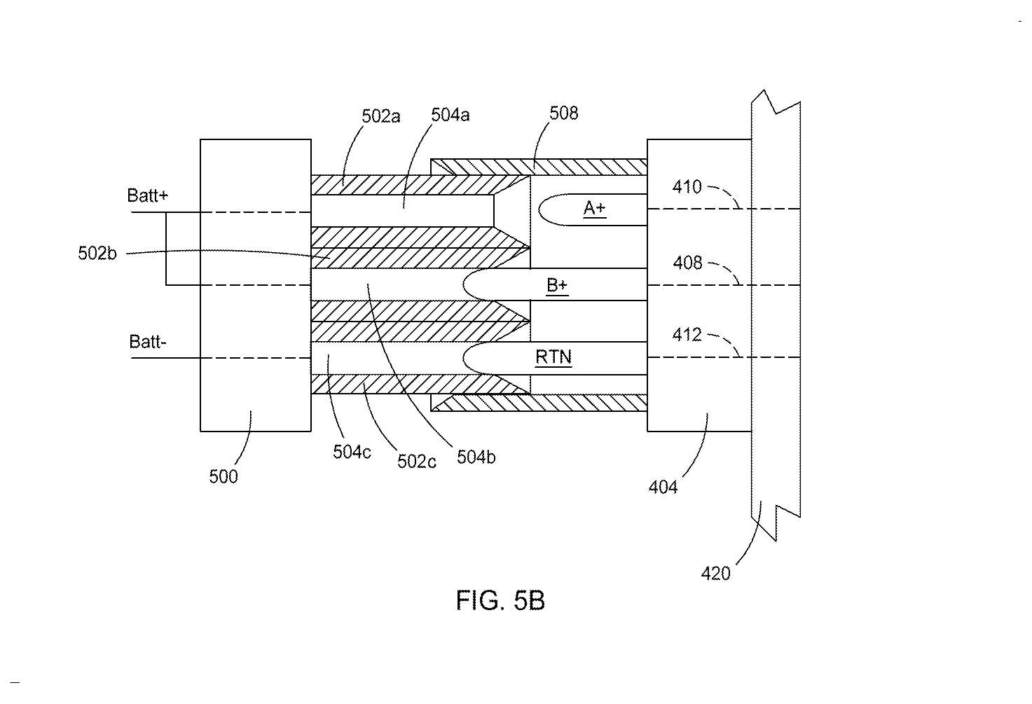

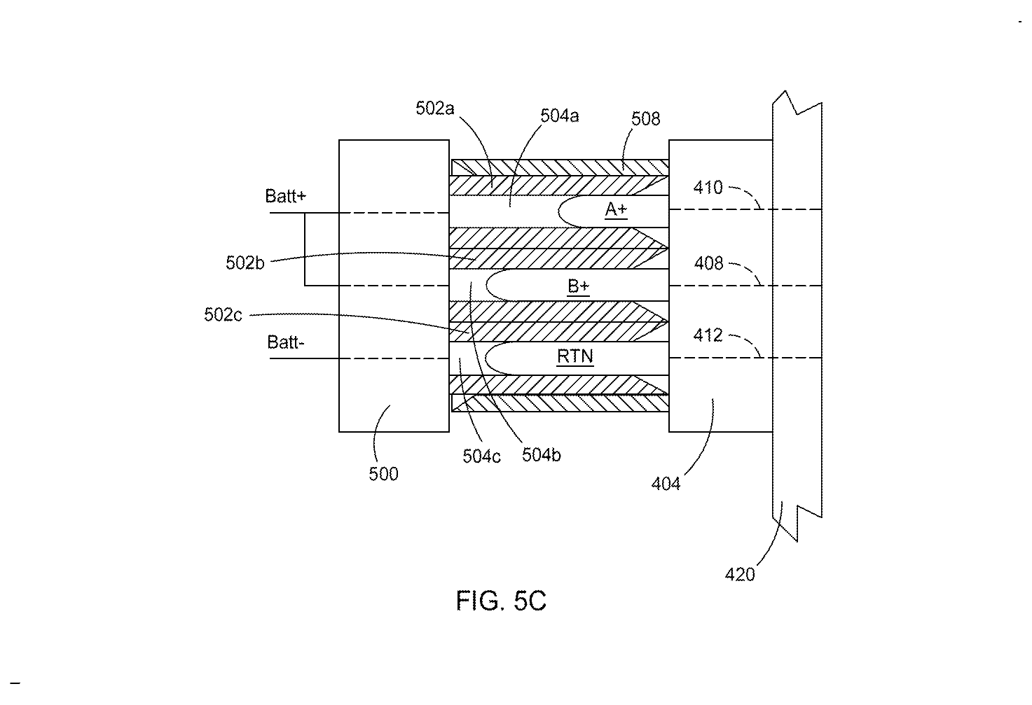

FIGS. 5A to 5C illustrate the process of engaging a plug 500 with the connector 402. The plug 500 may include a plurality of sleeves 502a, 502b, 502c, such as at least three, each including a conductive liner 504a, 504b, 504c. The sleeves 502a, 502b, 502c may be separate from one another or fused to one another along the lengths thereof, such as by co-molding. The distal portion of each sleeve 502a, 502b, 502c may include a flared portion 506a, 506b, 506c to facilitate insertion of the pins A+, B+, and RTN. The flared portion 506a, 506b, 506c may be non-conductive and extend to a depth such that the plug 500 is finger safe, i.e., does not pose a risk of accidental shock from being touched, such as according to the IPXXB standard. The conductive liners 504a, 504b are both coupled to the positive battery voltage (Batt+) and the conductive liner 504c is coupled to the negative battery voltage (Batt-).

As used herein, Batt+ and Batt- refer to voltage received from the battery 110, though not necessarily directly. For example, the Batt+ and Batt- may be received through one or more intermediate components such as filter elements including one or more inductors, a common-mode choke, or other component. The capacitance that contributes to ringing and inrush current may be a result of the capacitance 406 and possibly any capacitance of the intermediate components.

The pins A+, B+, RTN may be surrounded by a shroud 508 that protrudes outwardly from the connector body to a greater extent than the pins A+, B+, RTN such that contact with the pins A+, B+, RTN is not possible once energized from contact with the conductive liners 504a, 504b, 504c. For example, the configuration of the shroud 508 may comply with the IPXXB standard whether alone or in combination with the plug 500.

In some embodiments, the A+ pin is shorter, i.e., protrudes outwardly from the connector body 404 less, than the pin B+ pin and the pin RTN. The pins B+ and RTN may be the same length within manufacturing tolerances, e.g., within 0.1 mm, or .01 mm. The pin A+ may be shorter than the pins B+ and RTN by a distance 512 of at least 0.5 mm, 1 mm, 2 mm, or 4 mm. The distance 512 may be measured substantially (e.g., within 5 degrees of) parallel to the long dimension of the pins A+, B+, RTN. Where the pins A+, B+, RTN have a constant cross section portion (e.g., cylindrical) the distance 512 may be measured substantially parallel to the axis along which the pins A+, B+, RTN have constant cross sections.

The distance 512 may be such that when the plug 500 is moved toward the connector body 404 at a speed of between 2 and 8 meters per second, charging of the capacitor 406 of the DC-DC converter to a threshold percentage (e.g., at least 80 percent, at least 85 percent, at least 90 percent, or at least 95 percent) of the input voltage will occur in a time period between (a) when both pins B+ and RTN both make electrical contact with conductive liners 504b, 504c (see FIG. 5B) and (b) when the pin A+ makes electrical contact with conductive liner 504a (see FIG. 5C). Stated yet another way, for realistic insertion speeds by a human operator bringing the plug 500 and connector 402 together by hand, the distance 512 is such that capacitor 406 will be charged to at least 90 percent of the battery voltage by the time pin A+ makes electrical contact with the conductive liner 504a. For example, a realistic insertion speed may be defined as relative movement of between 2 and 8 meters per second.

Following insertion, the sleeves 502a, 502b, 502c are positioned within the shroud 508, which may abut the plug 500. Other retention features, such as locking tabs may be used to retain the shroud 508 relative to the plug 500 using any approach known in the art, particularly the motor vehicle industry.

The illustrated configuration is exemplary only. The illustrated connector 402 and plug 500 are examples of first and second interfaces, respectively, that may be configured to avoid ringing when connecting a capacitor to a battery. Such first and second interfaces may be configured in other ways. For example, the plug 500 may be mounted to the housing 420 of the DC-DC converter with conductive liner 504a connected to electrical path 410, conductive liner 504b connected to electrical path 408, and conductive liner 504c connected to electrical path 412. In such embodiments, the pins A+ and B+ may be connected to Batt+ and the pin RTN connected to Batt-.

In some embodiments, the pins A+, B+, and RTN are the same length within manufacturing tolerances (e.g., within 0.1 mm or within 0.01 mm) and the conductive liner 504a is shorter than the conductive liners 504b, 504c, such as by an amount corresponding to the distance 512 as defined above.

In some embodiments, both the conductive liner 504a and the pin A+ are shorter than the conductive liners 504b, 504c and pins B+ and RTN, respectively, with the combined differences in length achieving a delay between (a) contact between pins B+ and RTN and the conductive liners 504b, 504c and (b) contact between pin A+ and conductive liner 504c for a realistic insertion speed (e.g., 2 to 8 meters per second), the delay being sufficient to charge the capacitor 406 to at least 90 percent of the voltage of the battery for a given resistance of the resistor 400 and capacitance of the capacitor 406.

In some embodiments, polarity of the illustrated configuration may be reversed while achieving the same benefit. For example pins configured according to any of the embodiments of A+ and B+ could connect to Batt- and a pin configured as the pin RTN could connect to Batt+. Electrical path 408 (including resistor 400) and electrical path 410 could then connect to negative terminals of the other components 414 and the capacitor 406 and electrical paths 412, 418 could connect to the positive terminals of the other components 414 and the capacitor 406, respectively.

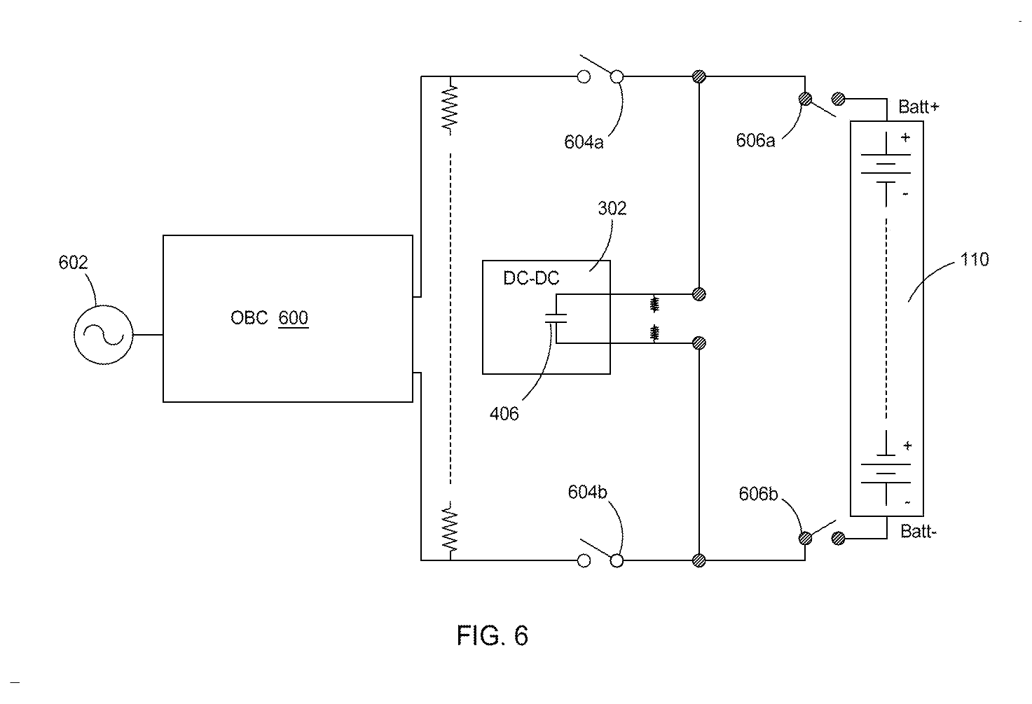

Referring to FIG. 6, in some embodiments, charging of the capacitor 406 of the DC-DC converter 302 may be facilitated by an onboard charger (OBC) 600 coupled to an AC power source 602. For example, outputs of the OBC 600 may be connected through switches 604a, 604b to the first and second terminals of the capacitor 406 within the DC-DC converter 302. Likewise, the first and second terminals of the capacitor 406 are connected through switches 606a, 606b to the positive and negative terminals (Batt+ and Batt-) of the battery 110, respectively.

During manufacture or following maintenance that results in draining of the capacitor 406, the switches 604a, 604b are closed with the switches 606a, 606b being open. The OBC 600 is then caused to convert AC current from the AC power source 602 to DC current substantially (e.g., within 10 percent of) equal to the voltage of the battery 110 for sufficient time to charge the capacitor, e.g., from 10 to 200 milliseconds. The switches 606a, 606b may thereafter be closed to connect the capacitor 406 to the battery 110. The switches 606a, 606b likewise connect the battery 110 to the OBC 600 thereby enabling charging of the battery 110 using the OBC 600. Alternatively, the DCDC converter 302 itself may be bidirectional and charge the capacitor 406 itself using an external 12V source connected to the DCDC converter 302.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A circuit, comprising:
a current limiting device;
a capacitor; and
a first interface, comprising:
a first pin connected to a first terminal of the capacitor through the current limiting device; and
a second pin connected to the first terminal of the capacitor in bypass of the current limiting device, the second pin being shorter than the first pin,
wherein the first interface is coupled to the capacitor and configured to couple to a second interface supplying an input voltage, the first interface further configured to couple the input voltage to the capacitor through the current limiting device before coupling the input voltage to the capacitor in bypass of the current limiting device.

2. The circuit of claim 1, wherein the second pin is at least 0.5 mm shorter than the first pin.

3. The circuit of claim 1, wherein a difference in length between the first pin and the second pin is effective to enable charging of the capacitor to a threshold percentage of the input voltage in a time period between contacting of the first pin by a first contact of a second interface and contacting of the second pin by a second contact of the second interface when the second interface and first interface are brought together.

4. The circuit of claim 3, wherein the threshold percentage is at least 90 percent, and the second interface and first interface are brought together at a speed of 0.5 to 8 meters per second.

5. The circuit of claim 1, wherein the first interface further comprises a third pin connected to a second terminal of the capacitor.

6. The circuit of claim 5, wherein the first pin has a lower current rating than the second pin and the third pin.

7. The circuit of claim 5, wherein the first pin has a current rating of less than 3 Amperes, and each of the second pin and the third pin have a current rating of at least 10 Amperes.

8. The circuit of claim 1, wherein the circuit comprises a direct current to direct current (DC-DC) converter.

9. The circuit of claim 8, wherein the first terminal is configured to couple the capacitor of the DC-DC converter to a vehicle on-board charger (OBC).

10. The circuit of claim 9, wherein the vehicle OBC is configured to couple to an AC power source.

11. The circuit of claim 9, wherein the DC-DC converter is configured to couple to the vehicle OBC via a first set of switches.

12. The circuit of claim 11, wherein the DC-DC converter is configured to couple to a vehicle battery via a second set of switches.

13. A method, comprising:
providing a circuit comprising a capacitor and a first interface, the first interface comprising:
a first pin connected to a first terminal of the capacitor through a current limiting device; and
a second pin connected to the first terminal of the capacitor in bypass of the current limiting device, the second pin being shorter than the first pin;
making first contact with the first interface via the first pin such that a voltage source is coupled to the capacitor through the current limiting device; and
making second contact with the first interface via the second pin such that the voltage source is coupled to the capacitor in bypass of the current limiting device.

14. The method of claim 13, wherein:
making the first contact comprises sliding the first interface and a second interface relative to one another such that the first interface is at a first position relative to a second interface; and
making the second contact comprises sliding the first interface and the second interface relative to one another such that the first interface moves past the first position by at least 0.5 mm to a second position relative to the second interface.

15. The method of claim 14, wherein the second interface includes a socket configured to receive the first pin and the second pin.

16. The method of claim 13, wherein the current limiting device includes at least one of a diode, a transistor, or a resistor.

17. A connector, comprising:
a connector body;
a first pin extending from the connector body by a first distance;
a second pin extending from the connector body by a second distance; and
a third pin extending from the connector body by a third distance, the first distance being at least 0.5 mm less than the second distance and the third distance.

18. The connector of claim 17, further comprising a shroud preventing finger contact with the first pin, the second pin, and the third pin according to the IPXXB standard.

19. The connector of claim 17, wherein the first pin has a lower current rating than the second pin and the third pin.

20. The connector of claim 17, wherein the first pin has a current rating of less than 3 Amperes, and each of the second pin and the third pin has a current rating of more than 10 Amperes.
